(19) United States
(12) Patent Application Publication
(10) Pub. No.: US 2025/0124598 A1
(43) Pub. Date: Apr. 17, 2025

(54) DEEP NEURAL NETWORK LEARNING METHOD FOR GENERALIZING APPEARANCE-BASED GAZE ESTIMATION AND APPARATUS FOR THE SAME

(71) Applicant: ELECTRONICS AND TELECOMMUNICATIONS RESEARCH INSTITUTE, Daejeon (KR)

(72) Inventors: Moon-Ki BACK, Daejeon (KR); Jang-Hee YOO, Daejeon (KR); Cheol-Hwan YOO, Daejeon (KR); Byung-Ok HAN, Daejeon (KR)

(21) Appl. No.: 18/795,557

(22) Filed: Aug. 6, 2024

(30) Foreign Application Priority Data
Oct. 13, 2023 (KR) 10-2023-0136842

(51) Int. Cl. G06T 7/73; G06V 10/776; G06V 10/82

(52) U.S. Cl. CPC G06T 7/74; G06V 10/776; G06V 10/82; G06T 2207/20081; G06T 2207/20084; G06T 2207/30201

(57) ABSTRACT

Disclosed herein are a deep neural network (DNN) learning method for generalizing appearance-based gaze estimation and an apparatus for the same. The deep neural network (DNN) learning method includes creating multiple augmented images based on an original image, inputting the multiple augmented images to a DNN to output a gaze estimation value, calculating a total loss between a gaze ground truth of the original image and the gaze estimation value through gaze consistency regularization (GCR) using a spherical gaze distance (SGD), and updating parameters of the DNN by backpropagation of the total loss.

### CROSS REFERENCE TO RELATED APPLICATION

This application claims the benefit of Korean Patent Application No. 10-2023-0136842, filed Oct. 13, 2023, which is hereby incorporated by reference in its entirety into this application.

### BACKGROUND OF THE INVENTION

### 1. Technical Field

The present disclosure relates to a deep neural network learning technology for generalizing appearance-based gaze estimation, and more particularly to, a domain generalization technology that induces to enable consistent gaze estimation even for a new portrait image that has not been used for learning in an appearance-based gaze estimation area for estimating a gaze by inputting a face image captured by a normal RGB camera to a deep neural network (DNN).

### 2. Description of Related Art

Gaze estimation is a technology belonging to a human-computer interaction (HCI) area, enabling natural interaction between human and computer by analyzing the person's intent, interest, physiological change, etc., from a change in gaze of the person. The gaze estimation technology may improve accessibility to the existing product and service, may be used for the purpose of establishing an effective marketing strategy, and may contribute to reducing accidents by detecting a dangerous situation such as distracted driving or drowsiness. Recently, the gaze estimation technology is being extensively applied to research and development for improving communion ability of social robots or to an assisted technique to diagnose a disease such as the autism spectrum disorder (ASD).

The gaze estimation technology is classified largely into a model-based approach and an appearance-based approach.

The model-based approach builds a geometric model of eyeballs and estimates a gaze by analyzing the pupil center and the iris shape. The model-based approach enables comparatively precise estimation, but calibration of an object targeted for gaze estimation needs to be assumed. The model-based approach including a calibration process is favorable for an application that requires precise gaze estimation for a particular person.

On the other hand, the appearance-based approach is a way of deriving a function that maps a face (or eye) image directly to a gaze direction, and does not typically require an extra calibration process. In the past, the person extracts a key feature related to the gaze from an image in person and estimates the gaze through traditional machine learning such as the support vector machine, but nowadays, as illustrated in FIG. 1, a DNN based gaze estimation technology to automatically extract a high-dimensional feature of the image and map this to low-dimensional gaze information is dominant. As the DNN enables gaze estimation of a new person without extra calibration only if a sufficient scale of learning data is supported, it is suitable for an application that requires consistent gaze estimation targeted at random people.

### PRIOR ART DOCUMENTS

### Patent Documents

(Patent Document 1) Korean Patent Application Publication No. 10-2021-0155317, Date of Publication: Dec. 22, 2021 (Title: 3D Gaze Estimation Method and Apparatus Using Multi-stream CNNs)

### SUMMARY OF THE INVENTION

Accordingly, the present disclosure has been made keeping in mind the above problems occurring in the prior art, and an object of the present disclosure is to propose a method of enhancing generalization performance, which is universally applicable to an appearance-based gaze estimation technology using a deep neural network (DNN).

Another object of the present disclosure is to present a method by which an error between a two dimensional (2D) gaze direction estimated by the DNN and a ground truth is measured in a three dimensional (3D) space and this may be learned.

A further object of the present disclosure is to present a regularization technology that enables high consistent gaze estimation even with a change in people and environment by alleviating an overfitting problem that often occurs in the DNN.

Yet another object of the present disclosure is to reduce expenses of building a learning dataset for a new domain and guarantee well-balanced gaze estimation performance for various domains at minimum costs by minimizing repeated relearning processes.

In accordance with an aspect of the present disclosure to accomplish the above objects, there is provided a deep neural network (DNN) learning method performed by a DNN learning apparatus for generalizing appearance-based gaze estimation, the DNN learning method including creating multiple augmented images based on an original image; inputting the multiple augmented images to a DNN to output a gaze estimation value; calculating a total loss between a gaze ground truth of the original image and the gaze estimation value through gaze consistency regularization (GCR) using a spherical gaze distance (SGD); and updating a parameter of the DNN by backpropagation of the total loss.

The spherical gaze distance may correspond to a shortest distance between two points on a curved surface when two dimensional (2D) gaze directions corresponding to a 2D vector form are projected onto respective points on a sphere with a radius of r.

The gaze estimation value may include a 2D gaze direction predicted for each of the multiple augmented images.

The total loss may be calculated by summing multiple loss values calculated using the 2D gaze direction predicted for each of the multiple augmented images and the gaze ground truth.

The calculating may include calculating a first spherical gaze distance (LOSS_GAZE) between a 2D gaze direction (y_pred_1) predicted for a first augmented image among the multiple augmented images and the gaze ground truth; calculating at least one second spherical gaze distance (LOSS_REG) between the 2D gaze direction (y_pred_1) predicted for the first augmented image and a 2D gaze direction (y_pred_#) predicted for at least one augmented image other than the first augmented image among the multiple augmented images; and calculating the total loss by summing the first spherical gaze distance (LOSS_GAZE) and the at least one second spherical gaze distance (LOSS_REG).

Creating the multiple augmented images may include creating the multiple augmented images by applying random augmentation except for flip and rotation to the original image.

In accordance with another aspect of the present disclosure to accomplish the above objects, there is provided a deep neural network (DNN) learning apparatus, including a processor configured to create multiple augmented images based on an original image, input the multiple augmented images to a DNN to output a gaze estimation value, calculate a total loss between a gaze ground truth of the original image and the gaze estimation value through gaze consistency regularization (GCR) using a spherical gaze distance (SGD), and update a parameter of the DNN by backpropagation of the total loss; and memory configured to store the DNN.

The spherical gaze distance may correspond to a shortest distance between two points on a curved surface when two dimensional (2D) gaze directions corresponding to a 2D vector form are projected onto respective points on a sphere with a radius of r.

The gaze estimation value may include a 2D gaze direction predicted for each of the multiple augmented images.

The total loss may be calculated by summing multiple loss values calculated using the 2D gaze direction predicted for each of the multiple augmented images and the gaze ground truth.

The processor may be configured to calculate a first spherical gaze distance (LOSS_GAZE) between a 2D gaze direction (y_pred_1) predicted for a first augmented image among the multiple augmented images and the gaze ground truth, calculate at least one second spherical gaze distance (LOSS_REG) between the 2D gaze direction (y_pred_1) predicted for the first augmented image and a 2D gaze direction (y_pred_#) predicted for at least one augmented image other than the first augmented image among the multiple augmented images, and calculate the total loss by summing the first spherical gaze distance (LOSS_GAZE) and the at least one second spherical gaze distance (LOSS_REG).

The processor may be configured to create the multiple augmented images by applying random augmentation except for flip and rotation to the original image.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a diagram illustrating an example of appearance-based gaze estimation that uses a deep neural network (DNN);

FIG. 2 is an operation flowchart illustrating a DNN learning method for generalizing appearance-based gaze estimation according to an embodiment of the present disclosure;

FIG. 3 is a diagram illustrating an example of a typical appearance-based gaze estimation procedure using a DNN;

FIG. 4 is a diagram illustrating an example of a spherical gaze distance (SGD) according to the present disclosure;

FIG. 5 is a diagram illustrating an example of a domain generalization procedure through an SGD and gaze consistency regularization (GCR) according to the present disclosure;

FIG. 6 is a block diagram illustrating a DNN learning apparatus for generalizing appearance-based gaze estimation according to an embodiment of the present disclosure; and

FIG. 7 is a diagram illustrating a DNN learning apparatus for generalizing appearance-based gaze estimation according to another embodiment of the present disclosure.

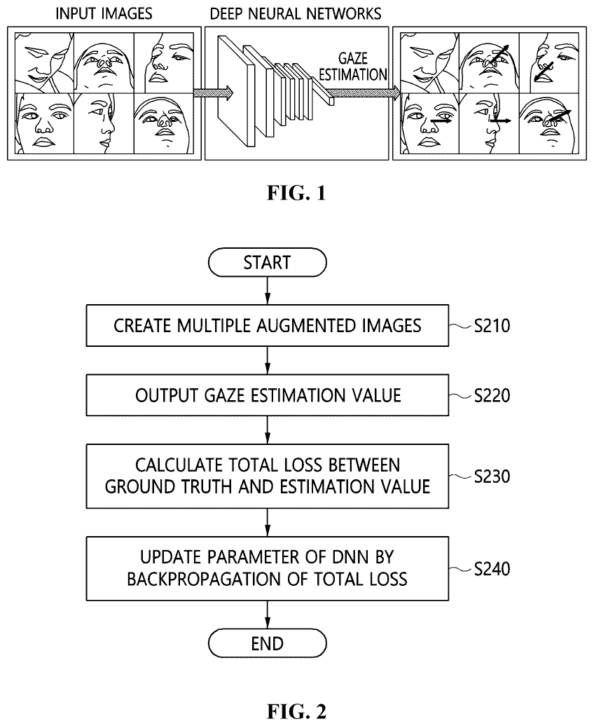

### DESCRIPTION OF THE PREFERRED EMBODIMENTS

The present disclosure will be described in detail below with reference to the accompanying drawings. Repeated descriptions and descriptions of known functions and configurations which have been deemed to make the gist of the present disclosure unnecessarily obscure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated to make the description clearer.

In the present specification, each of phrases such as “A or B”, “at least one of A and B”, “at least one of A or B”, “A, B, or C”, “at least one of A, B, and C”, and “at least one of A, B, or C” may include any one of the items enumerated together in the corresponding phrase, among the phrases, or all possible combinations thereof.

Hereinafter, preferred embodiments of the present disclosure will be described in detail with reference to the attached drawings.

Appearance-based gaze estimation using a deep neural network (DNN) requires a gaze dataset including n samples where an image x and a two dimensional (2D) gaze direction y are paired, to train DNN(f(·)) that maps a given face image to a 2D gaze direction. The 2D gaze direction is generally represented using angle units, and refers to vertical (pitch) and horizontal (yaw) rotation degrees based on a head coordinate system. The 2D gaze direction represented with the pitch and yaw may be converted to a three dimensional (3D) gaze direction (in a 3D unit vector form), so the most research and development uses the 2D gaze direction as a label by taking into account learning efficiency of the DNN. Specifically, a given face image is input to the DNN to predict a 2D gaze direction f(x), an error between the 2D gaze direction f(x) and the label is calculated using a p-norm distance (∥f(x)−y∥ₚ), and DNN learning is performed in a procedure for updating parameters of the DNN by backpropagation of the error.

Traditional technologies train the DNN by mainly using an L1 loss function with p being ‘1’, but comparing of different 2D gaze directions represented by angles with an L1 distance on the plane is not a perceptually appropriate way and hardly considered as an optimal loss function. Hence, a loss function specialized in gaze estimation that may map a label represented as a 2D gaze direction and a predicted value of the DNN onto a 3D space and perceptually compare the difference needs to be designed.

In general, the DNN tends to have generalization performance increasing in proportion with the size and diversity of the learning dataset. A dataset with insufficient size and diversity causes an overfitting problem that significantly restricts the performance that the DNN may have otherwise. For example, in a case of a gaze estimation task, when face images collected in a situation where the number of subjects included in the learning dataset is very small or significantly limited are used in learning, correct gaze estimation becomes difficult for a new person or environment. In other words, appearance-based gaze tracking technologies using the DNN tend to depend on the given learning dataset. Hence, the traditional technology makes full use of regularization scheme that complements the size and diversity of the dataset itself through data augmentation and imposes restrictions on the procedure for updating parameters of the DNN. However, the schemes are developed to take into account image classification tasks and hardly considered as a suitable scheme for regression analysis for predicting continuous values like gaze estimation.

Hence, a new method of deriving optimal generalization performance from a given learning dataset needs to be provided by designing a regularization scheme universally applicable to gaze estimation tasks.

The present disclosure proposes a regularization method that promotes improvement of gaze estimation ability and induces to have a highly consistent gaze estimated by the DNN even with variation of input images by designing a new loss function that enables DNN learning from a 3D perceptual perspective in order to improve domain generalization ability of the DNN for gaze estimation.

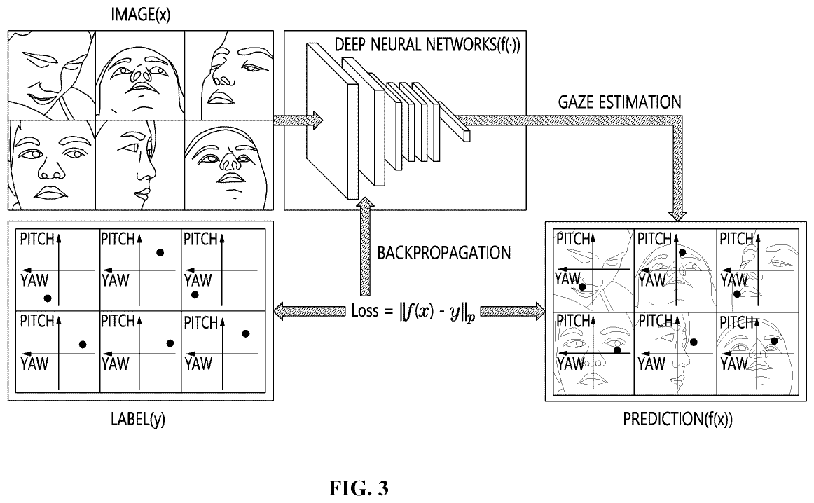

FIG. 2 is an operation flowchart illustrating a DNN learning method for generalizing appearance-based gaze estimation according to an embodiment of the present disclosure.

Referring to FIG. 2, in the DNN learning method for generalizing appearance-based gaze estimation, a DNN learning apparatus for generalizing appearance-based gaze estimation creates multiple augmented images based on an original image, at step S210.

The original image is included in a gaze dataset to train the DNN, and may correspond to a face (or eyes) image captured by a normal RGB camera.

The gaze dataset may be composed of a pair of the original image and a corresponding label, gaze ground truth.

The label may refer to a 2D gaze direction obtained by representing a gaze direction in angles (pitch and yaw) based on a head coordinate system.

The multiple augmented images may be created by applying random augmentation except for flip and rotation to the original image.

The random augmentation is a frequently used scheme to increase diversity and size of the learning dataset in deep learning areas, and may use all the techniques such as overall adjustment of pixel values such as saturation, brightness, etc., of the image or filling of an arbitrary area in the image with particular values (cutout), translation of the whole image onto the x-axis or y-axis, etc.

For example, N augmented images may be created by varying or manipulating image pixel values from the single original image.

However, the random augmentation in the present disclosure excludes the technique such as flip or rotation, by which the original 2D gaze direction y is changed by data augmentation.

Furthermore, in the DNN learning method for generalizing appearance-based gaze estimation, the DNN learning apparatus for generalizing appearance-based gaze estimation inputs the multiple augmented images to the DNN to output a gaze estimation value at step S220.

The gaze estimation value may include a 2D gaze direction predicted for each of the multiple augmented images.

For example, as illustrated in FIG. 3, it may be assumed that n augmented images x_aug_1, x_aug_2, . . . . Are created by applying random augmentation before inputting Image(x) to be used as learning data to the DNN, where n≥2. Each of the n augmented images created by the random augmentation may then be input to the DNN to estimate a 2D gaze direction for each augmented image.

Moreover, in the DNN learning method for generalizing appearance-based gaze estimation, the DNN learning apparatus for generalizing appearance-based gaze estimation calculates a total loss between the gaze ground truth of the original image and the gaze estimation value through gaze consistency regularization (GCR) using a spherical gaze distance (SGD), at step S230.

As illustrated in FIG. 3, a Manhattan or Euclidean distance between the estimated gaze Prediction (f(x)) and the label (Label(y)) may be used as an error for backpropagation.

Specifically, the gaze ground truth corresponding to the label and the gaze estimation value (prediction) are in a 2D vector form, so a p-norm distance may be used to calculate the error. However, as an actual label refers to a unit vector rotated by pitch and yaw with respect to vertical and horizontal axes in the 3D space, the axial scale changes non-linearly by projecting the pitch and yaw values intact onto a 2D space. The farther from the origin, the further the scale is reduced, so a standardized distance measurement method is required to measure a distance with consistency.

To solve the aforementioned problem, a method of performing learning by converting the label in the 2D vector form to a 3D vector in DNN learning may be considered, but in this case, parameters to be considered may increase along with the increased dimension to be predicted by the DNN and learning efficiency of the DNN is likely to be rather lowered, and there is a burden of having to allocate additional computing resources.

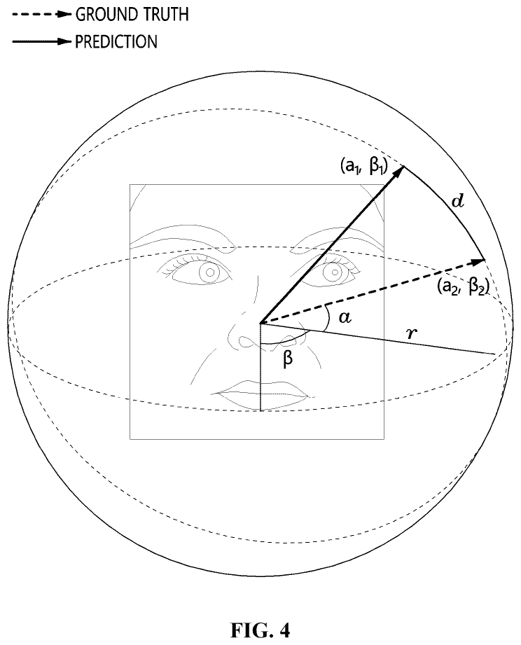

Hence, the present disclosure proposes a spherical gaze distance (SGD), as illustrated in FIG. 4, which may be directly used (differential) in DNN learning while maintaining the gaze ground truth and the gaze estimated value in the 2D vector form and which enables measuring of a standardized distance for all directions.

The SGD may correspond to a shortest distance between two points on a curved surface when two 2D gaze directions corresponding to a 2D vector form are projected onto respective points on a sphere with a radius of r.

Hence, the SGD returns a standardized difference in distance in constant units as in Equation (1).

$${L}_{sgd} = d = 2 r arcsin ( \sqrt{{sin}^{2} ( \frac{{α}_{2} - {α}_{1}}{2} ) + cos ( {a}_{1} ) cos ( {α}_{2} ) {sin}^{2} ( \frac{{β}_{2} - {β}_{1}}{2} ) + σ} ) \qquad ( 1 )$$

d: SGD between two points on a spherical surface
α: vertical gaze angle (pitch)
β: horizontal gaze angle (yaw)
σ: 1E-8 (a small value for numerical stability to avoid a square root-to-zero problem)
r: 1 (radius)

In this case, to avoid the square root-to-zero problem due to the gaze ground truth and the gaze estimation value being the same, numerical stability in the backpropagation procedure of the DNN may be guaranteed by adding the small value σ.

The present disclosure also proposes the gaze consistency regularization (GCR) to induce to have a consistent gaze estimated by the DNN even with a change in input image, and enhances the generalization ability of the DNN by using the aforementioned spherical gaze distance.

The total loss may be calculated by summing multiple loss values computed using the 2D gaze direction predicted for each of the multiple augmented images and the gaze ground truth.

Specifically, a first spherical gaze distance LOSS_GAZE between a 2D gaze direction y_pred_1 predicted for a first augmented image among the multiple augmented images and the gaze ground truth may be calculated, at least one second spherical gaze distance LOSS_REG between a 2D gaze direction y_pred_1 predicted for the first augmented image and a 2D gaze direction y_pred_#predicted for at least one augmented image other than the first augmented image among the multiple augmented images may be calculated, and the total loss may be calculated by summing the first spherical gaze distance LOSS_GAZE and the at least one second spherical gaze distance LOSS_REG.

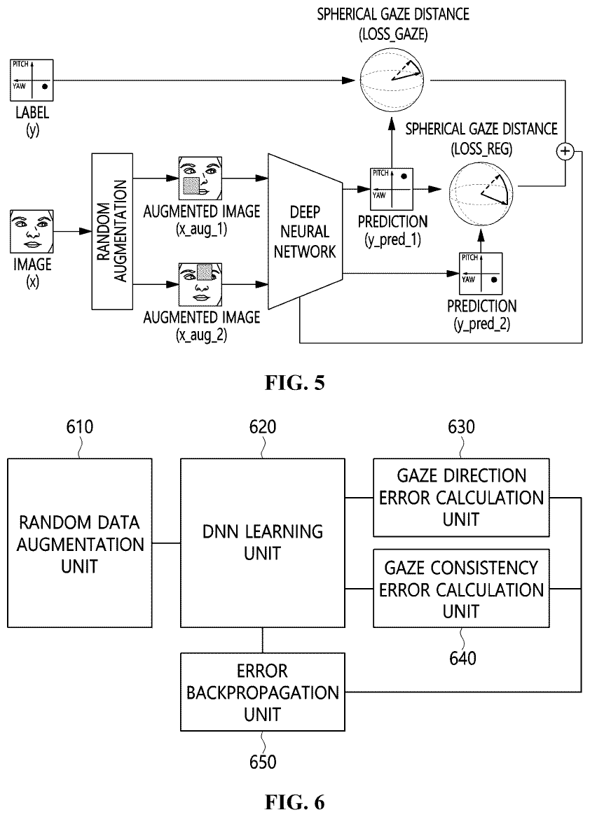

For example, referring to FIG. 5, it may be assumed that n augmented images x_aug_1, x_aug_2, . . . . Are created through random augmentation for Image(x) used as learning data, where n≥2, and the n augmented images are each input to the DNN to estimate a 2D gaze direction of each augmented image.

In this case, a first spherical gaze distance LOSS_GAZE between a 2D gaze direction y_pred_1 predicted for the first augmented image x_aug_1 and the gaze ground truth Label may be calculated. Subsequently, a second spherical gaze distance LOSS_REG between a 2D gaze direction y_pred_2 predicted for the second augmented image x_aug_2 and the 2D gaze direction y_pred_1 predicted for the first augmented image x_aug_1 may be calculated. A total loss may then be calculated by summing the first spherical gaze distance LOSS_GAZE and the second spherical gaze distance LOSS_REG.

When n is 3 or more, the total loss is calculated by calculating a spherical gaze distance between y_pred_1 and y_pred_n for n being 2 or more and obtaining the cumulative sum. Specifically, when there is a third augmented image x_aug_3, a second spherical gaze distance LOSS_REG between a 2D gaze direction y_pred_3 predicted for the third augmented image x_aug_3 and the 2D gaze direction y_pred_1 predicted for the first augmented image x_aug_1 may be further calculated, and the total loss may be calculated by accumulating the previously calculated losses.

Furthermore, in the DNN learning method for generalizing appearance-based gaze estimation, the DNN learning apparatus for generalizing appearance-based gaze estimation updates parameters of the DNN through backpropagation of the total loss, at step S240.

In other words, as illustrated in FIG. 5, DNN learning may proceed by updating parameters of the DNN through backpropagation of the total loss.

In this case, as LOSS_GAZE included in the total loss is calculated using augmented images, parameters of the DNN may be updated to perform basic gaze estimation while relieving a phenomenon in which the DNN is overfitted to a given dataset. Furthermore, LOSS_REG included in the total loss may enhance the overall domain generalization ability by updating the parameters of the DNN to estimate a gaze of the similar direction even with a change in input image.

With the DNN learning method for generalizing appearance-based gaze estimation, a method of enhancing generalization performance, which is universally applicable to the appearance-based gaze estimation technology using the DNN, may be provided.

Furthermore, a method, by which an error between a 2D gaze direction estimated by the DNN and a ground truth in a 3D space is measured and this is learned, may be provided. Specifically, the present disclosure may measure a distance by converting a non-linear scale 2D gaze direction onto a linear scale 3D spherical surface in a method of measuring a distance on the spherical surface by mapping different 2D gaze directions onto the 3D spherical surface. Providing an error measurement method for all directional 2D gaze directions in constant units may induce the DNN to be trained from a rather 3D perceptual perspective.

A regularization technology that enables highly consistent gaze estimation even with a change in people and environment may be provided by relieving an overfitting problem that often occurs in the DNN. The traditional appearance-based gaze estimation technology resolves the overfitting problem by simply augmenting data or using the regularization scheme that is often used in the existing deep learning area, such as adjusting parameters in the DNN. However, gaze estimation is a sort of a matter of regression that estimates a gaze direction represented with continuous values, so the present disclosure provides a regularization method that induces consistent gaze estimation even with a change in input image by taking into account that a small change in image input to the DNN have big influence on the estimated gaze.

The present disclosure may reduce expenses of building a learning dataset for a new domain and guarantee well-balanced gaze estimation performance for various domains at minimum costs by minimizing repeated relearning processes.

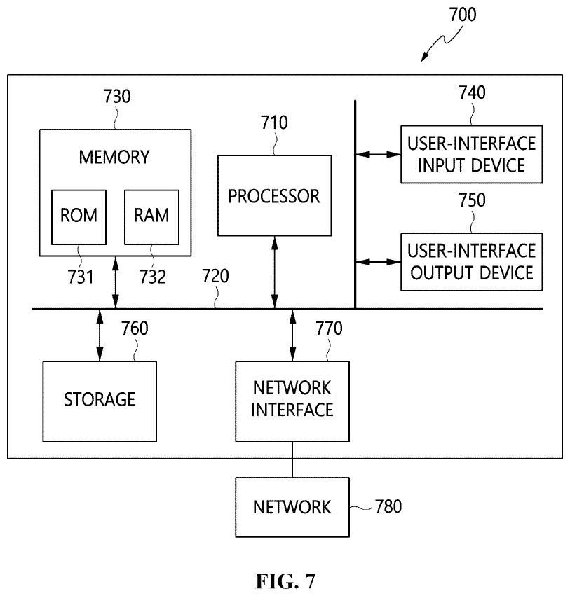

FIG. 6 is a block diagram illustrating a DNN learning apparatus for generalizing appearance-based gaze estimation according to an embodiment of the present disclosure.

Referring to FIG. 6, a DNN learning apparatus for generalizing appearance-based gaze estimation includes a random data augmentation unit 610, a DNN learning unit 620, a gaze direction error calculation unit 630, a gaze consistency error calculation unit 640 and an error backpropagation unit 650.

The random data augmentation unit 610 creates n augmented images by changing or manipulating image pixel values from a single original image.

The DNN learning unit 620 includes a DNN having multiple parameters and outputs a gaze estimated by inputting the n augmented images created by the random data augmentation unit 610 to the DNN.

The gaze direction error calculation unit 630 is a part for calculating an error between the gaze estimated by the DNN learning unit 620 and a ground truth (label) by using not only a well-known method of measuring a distance such as the p-norm distance but also the spherical gaze distance proposed by the present disclosure.

The gaze consistency error calculation unit 640 is a part for calculating a consistency error between the n gazes estimated by the DNN learning unit 620 for the corresponding n augmented images by using, like the gaze direction error calculation unit 630, not only a well-known method of measuring a distance such as the (p-norm distance but also the spherical gaze distance proposed by the present disclosure.

The error backpropagation unit 650 calculates a total loss by giving weights to n errors calculated by the gaze direction error calculation unit 630 and the gaze consistency error calculation unit 640, and updates the parameters of the DNN included in the DNN learning unit 620 while performing backpropagation with the total loss.

Domain generalization of the DNN may be attained by repeatedly performing the series of learning procedures.

FIG. 7 is a diagram illustrating a DNN learning apparatus for generalizing appearance-based gaze estimation according to another embodiment of the present disclosure.

Referring to FIG. 7, the DNN learning apparatus for generalizing appearance-based gaze estimation may be implemented in a computer system such as a computer readable storage medium. As illustrated in FIG. 7, a computer system 700 may include one or more processors 710, memory 730, a user interface input device 740, a user interface output device 750, and storage 760, which communicate with each other through a bus 720. The computer system 700 may further include a network interface 770 connected to a network 780. Each processor 710 may be a Central Processing Unit (CPU) or a semiconductor device for executing processing instructions stored in the memory 730 or the storage 760. Each of the memory 730 and the storage 760 may be any of various types of volatile or nonvolatile storage media. For example, the memory 730 may include Read-Only Memory (ROM) 731 or Random Access Memory (RAM) 732.

Therefore, the embodiment of the present disclosure may be implemented as a non-transitory computer-readable medium in which a computer-implemented method or computer-executable instructions are stored. When the computer-readable instructions are executed by the processor, the computer-readable instructions may perform the method according to at least one aspect of the present disclosure.

The processor 710 creates multiple augmented images based on an original image.

The original image is included in a gaze dataset to train the DNN, and may correspond to a face (or eyes) image captured by a normal RGB camera.

The gaze dataset may be composed of a pair of the original image and a corresponding label, gaze ground truth.

The label may refer to a 2D gaze direction obtained by representing a gaze direction in angles (pitch and yaw) based on a head coordinate system.

The multiple augmented images may be created by applying random augmentation except for flip and rotation to the original image.

The random augmentation is a frequently used scheme to increase diversity and size of the learning dataset in deep learning areas, and may use all the techniques such as overall adjustment of pixel values such as saturation, brightness, etc., of the image or filling of an arbitrary area in the image with particular values (cutout), translation of the whole image onto the x-axis or y-axis, etc.

For example, N augmented images may be created by varying or manipulating image pixel values from the single original image.

However, the random augmentation in the present disclosure does not use a technique such as flip or rotation, by which the gaze information is changed by data augmentation.

The processor 710 outputs a gaze estimation value by inputting the multiple augmented images to the DNN.

The gaze estimation value may include a 2D gaze direction predicted for each of the multiple augmented images.

For example, as illustrated in FIG. 3, it may be assumed that n augmented images x_aug_1, x_aug_2, . . . . Are created by applying random augmentation before inputting Image(x) to be used as learning data to the DNN, where n≥2. Each of the n augmented images created by the random augmentation may then be input to the DNN to estimate a 2D gaze direction for each augmented image.

The processor 710 calculates a total loss between the gaze ground truth of the original image and the gaze estimation value through gaze consistency regularization (GCR) using a spherical gaze distance (SGD).

As illustrated in FIG. 3, a Manhattan or Euclidean distance between the estimated gaze Prediction (f(x)) and the label (Label(y)) may be used as an error for backpropagation.

Specifically, the gaze ground truth corresponding to the label and the gaze estimation value (prediction) are in a 2D vector form, so a p-norm distance may be used to calculate the error. However, as an actual label refers to a unit vector rotated by pitch and yaw with respect to vertical and horizontal axes in the 3D space, the axial scale changes non-linearly by projecting the pitch and yaw values intact onto a 2D space. The farther from the origin, the further the scale is reduced, so a standardized distance measurement method is required to measure a distance with consistency.

To solve the aforementioned problem, a method of performing learning by converting the label in the 2D vector form to a 3D vector in DNN learning may be considered, but in this case, learning efficiency of the DNN is likely to be rather lowered along with the increased dimension to be predicted by the DNN, and there is a burden of having to change the existing DNN structure.

Hence, the present disclosure proposes a spherical gaze distance (SGD), as illustrated in FIG. 4, which may be directly used (differential) in DNN learning while maintaining the gaze ground truth and the gaze estimated value in the 2D vector form and which is able to measure a standardized distance for all directions.

The spherical gaze distance may correspond to a shortest distance between two points on a curved surface when two 2D gaze directions corresponding to a 2D vector form are projected onto respective points on a sphere with a radius of r.

Hence, the spherical gaze distance returns a standardized distance difference in constant units as in Equation (1).

In this case, to avoid the square root-to-zero problem due to the gaze ground truth and the gaze estimation value being the same, numerical stability in the backpropagation procedure of the DNN may be guaranteed by adding the small value σ.

The present disclosure also proposes the gaze consistency regularization (GCR) to induce to have a consistent gaze estimated by the DNN even with a change in input image, and enhances the generalization ability of the DNN by using the aforementioned spherical gaze distance.

The total loss may be calculated by summing multiple loss values computed using the 2D gaze direction predicted for each of the multiple augmented images and the gaze ground truth.

Specifically, a first spherical gaze distance LOSS_GAZE between a 2D gaze direction y_pred_1 predicted for a first augmented image among the multiple augmented images and the gaze ground truth may be calculated, at least one second spherical gaze distance LOSS_REG between a 2D gaze direction y_pred_1 predicted for the first augmented image and a 2D gaze direction y_pred_#predicted for at least one augmented image other than the first augmented image among the multiple augmented images may be calculated, and the total loss may be calculated by summing the first spherical gaze distance LOSS_GAZE and the at least one second spherical gaze distance LOSS_REG.

For example, referring to FIG. 5, it may be assumed that n augmented images x_aug_1, x_aug_2, . . . . Are created through random augmentation for Image(x) used as learning data, where n≥2, and the n augmented images are each input to the DNN to estimate a 2D gaze direction of each augmented image.

In this case, a first spherical gaze distance LOSS_GAZE between a 2D gaze direction y_pred_1 predicted for the first augmented image x_aug_1 and the gaze ground truth Label may be calculated. Subsequently, a second spherical gaze distance LOSS_REG between a 2D gaze direction y_pred_2 predicted for the second augmented image x_aug_2 and the 2D gaze direction y_pred_1 predicted for the first augmented image x_aug_1 may be calculated. A total loss may then be calculated by summing the first spherical gaze distance LOSS_GAZE and the second spherical gaze distance LOSS_REG.

When n is 3 or more, the total loss is calculated by calculating a spherical gaze distance between y_pred_1 and y_pred_n for n being 2 or more and obtaining the cumulative sum. Specifically, when there is a third augmented image x_aug_3, a second spherical gaze distance LOSS_REG between a 2D gaze direction y_pred_3 predicted for the third augmented image x_aug_3 and the 2D gaze direction y_pred_1 predicted for the first augmented image x_aug_1 may be further calculated, and the total loss may be calculated by accumulating the previously calculated losses.

The processor 710 updates parameters of the DNN by backpropagation of the total loss.

In other words, as illustrated in FIG. 5, DNN learning may proceed by updating parameters of the DNN through backpropagation of the total loss.

In this case, as LOSS_GAZE included in the total loss is calculated using augmented images, parameters of the DNN may be updated to perform basic gaze estimation while relieving a phenomenon in which the DNN is overfitted to a given dataset. Furthermore, LOSS_REG included in the total loss may enhance the overall domain generalization ability by updating the parameters of the DNN to estimate a gaze of the similar direction even with a change in input image.

The memory 730 stores the DNN.

The memory 73 also stores various types of information occurring in the DNN learning device for generalizing appearance-based gaze estimation as described above.

In an embodiment, the memory 730 is configured separately from the DNN learning apparatus to support a function for DNN learning for generalizing appearance-based gaze estimation. In this case, the memory 730 may operate as a separate mass storage and include a control function to perform an operation.

In an embodiment, the memory may be implemented as a computer-readable medium. In an embodiment, the memory may be a volatile memory unit, and in another embodiment, the memory may be a non-volatile memory unit. In an embodiment, the storage may be implemented as a computer-readable medium. In various embodiments, the storage may include e.g., a hard disk, an optical disc, or any other mass storage device.

The DNN learning apparatus for generalizing appearance-based gaze estimation may be used to enhance domain generalization ability of a device that provides services based on a change in human gaze.

The traditional apparatuses for estimating a gaze using a DNN have a limitation in that it is difficult to estimate a correct gaze for a new domain (new environment and person), and the limitation leads to deterioration of service quality. The traditional technologies improve the limitation by obtaining an additional learning dataset and retraining the DNN, but huge expenses and time are consumed for obtaining new data and retraining the DNN.

The DNN learning apparatus according to the present disclosure may be applied to most of the gaze estimation apparatuses required to provide continuous services in various domains, and have an effect of guaranteeing well-balanced gaze estimation performance for various domains at minimum expenses by saving the learning dataset building cost for a new domain and minimizing the repeated relearning procedures.

As a change in gaze of the person indirectly includes the person's intent and interest, the present disclosure may improve interaction ability of a social robot which communicates with random people and may be used for an aid to avoid accidents by more accurately detecting the change in gaze of the person that occurs due to physiologic changes such as drowsiness. Furthermore, it may be extensively applied to a diagnostic aid for early detection of autism spectrum disorder, which shows different behavior patterns from ordinary infants and toddlers.

According to the present disclosure, a method of enhancing generalization performance, which is universally applicable to an appearance-based gaze estimation technology using a deep neural network (DNN), may be provided.

The present disclosure may also provide a method by which an error between a two dimensional (2D) gaze direction estimated by the DNN and a ground truth is measured in a three dimensional (3D) space and this may be learned.

The present disclosure may also provide a regularization technology that enables high consistent gaze estimation even with a change in people and environment by alleviating an overfitting problem that often occurs in the DNN.

Furthermore, the present disclosure may reduce expenses of building a learning dataset for a new domain and guarantee well-balanced gaze estimation performance for various domains at minimum costs by minimizing repeated relearning processes.

As described above, in the DNN learning method for generalizing appearance-based gaze estimation and the apparatus for the DNN learning method according to the present disclosure, the configurations and schemes in the above-described embodiments are not limitedly applied, and some or all of the above embodiments can be selectively combined and configured such that various modifications are possible.

What is claimed is:

1. A deep neural network (DNN) learning method performed by a DNN learning apparatus for generalizing appearance-based gaze estimation, the DNN learning method comprising:
creating multiple augmented images based on an original image;
inputting the multiple augmented images to a DNN to output a gaze estimation value;
calculating a total loss between a gaze ground truth of the original image and the gaze estimation value through gaze consistency regularization (GCR) using a spherical gaze distance (SGD); and
updating a parameter of the DNN by backpropagation of the total loss.

2. The DNN learning method of claim 1, wherein the spherical gaze distance corresponds to a shortest distance between two points on a curved surface when two dimensional (2D) gaze directions corresponding to a 2D vector form are projected onto respective points on a sphere with a radius of r.

3. The DNN learning method of claim 1, wherein the gaze estimation value comprises a 2D gaze direction predicted for each of the multiple augmented images.

4. The DNN learning method of claim 3, wherein the total loss is calculated by summing multiple loss values calculated using the 2D gaze direction predicted for each of the multiple augmented images and the gaze ground truth.

5. The DNN learning method of claim 4, wherein the calculating comprises:
calculating a first spherical gaze distance (LOSS_GAZE) between a 2D gaze direction (y_pred_1) predicted for a first augmented image among the multiple augmented images and the gaze ground truth;
calculating at least one second spherical gaze distance (LOSS_REG) between the 2D gaze direction (y_pred_1) predicted for the first augmented image and a 2D gaze direction (y_pred_#) predicted for at least one augmented image other than the first augmented image among the multiple augmented images; and
calculating the total loss by summing the first spherical gaze distance (LOSS_GAZE) and the at least one second spherical gaze distance (LOSS_REG).

6. A deep neural network (DNN) learning apparatus, comprising:
a processor configured to create multiple augmented images based on an original image, input the multiple augmented images to a DNN to output a gaze estimation value, calculate a total loss between a gaze ground truth of the original image and the gaze estimation value through gaze consistency regularization (GCR) using a spherical gaze distance (SGD), and update a parameter of the DNN by backpropagation of the total loss; and
a memory configured to store the DNN.

7. The DNN learning apparatus of claim 6, wherein the spherical gaze distance corresponds to a shortest distance between two points on a curved surface when two dimensional (2D) gaze directions corresponding to a 2D vector form are projected onto respective points on a sphere with a radius of r.

8. The DNN learning apparatus of claim 6, wherein the gaze estimation value comprises a 2D gaze direction predicted for each of the multiple augmented images.

9. The DNN learning apparatus of claim 8, wherein the total loss is calculated by summing multiple loss values calculated using the 2D gaze direction predicted for each of the multiple augmented images and the gaze ground truth.

10. The DNN learning apparatus of claim 9, wherein the processor is configured to calculate a first spherical gaze distance (LOSS_GAZE) between a 2D gaze direction (y_pred_1) predicted for a first augmented image among the multiple augmented images and the gaze ground truth, calculate at least one second spherical gaze distance (LOSS_REG) between the 2D gaze direction (y_pred_1) predicted for the first augmented image and a 2D gaze direction (y_pred_#) predicted for at least one augmented image other than the first augmented image among the multiple augmented images, and calculate the total loss by summing the first spherical gaze distance (LOSS_GAZE) and the at least one second spherical gaze distance (LOSS_REG).
